(19) United States
(12) Patent Application Publication
(10) Pub. No.: US 2008/0126425 A1
(43) Pub. Date: May 29, 2008

(54) Chemical Information Management System and Methods of Using the Same

(76) Inventors: Caroline Winyard Cardin, Cincinnati, OH (US); Ping Hu, Fairfield, OH (US); Karen A. Kohrman, Cincinnati, OH (US); Genevieve Hilgers, Brussels (BE); Jun Xu, Mason, OH (US); Joseph Patrick Feeley, Green Township, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/947,394

(22) Filed: Nov. 29, 2007

Related U.S. Application Data
(60) Provisional application No. 60/867,630, filed on Nov. 29, 2006.

(51) Int. Cl. G06F 17/30

(52) U.S. Cl. 707/104.1; 707/E17.009

(57) ABSTRACT

In general, the present invention, and in various exemplary embodiments, provides a chemical management information system and methods of using the same. The chemical management system captures chemical use on an on-going and real-time basis regardless of the source of data. The chemical management system integrates chemical usage information by user input and from a plurality of sources. It also allows for the evaluation of a chemical in minutes rather than days, and further allows a user to submit this information to the governing body requiring the information in a simple step. In one embodiment, the chemical management system comprises a web-based use capture tool, a compliance tool, a safety database search tool, and a gap analysis tool.

### CROSS REFERENCE TO RELATED APPLICATION

This application claims the benefit of U.S. Provisional Application No. 60/867,630, filed Nov. 29, 2006.

### FIELD OF THE INVENTION

The present invention relates generally to an integrated web-based system and, in particular, to a chemical information management system that provides real-time information such as a company's particular usage of a chemical, its classification, chemical safety data reports, and any other information that may be useful in monitoring the chemical. The present invention has particular utility in complying with various governing body's rules and regulations regarding chemical usage in their respective countries.

### BACKGROUND OF THE INVENTION

Proper chemical management is a concern that affects many companies because of governmental regulations. For instance, companies may be obligated to conduct safety studies to ensure that the chemicals contained in consumer products are safe to use. Companies may also be required to track certain chemicals because of bio-terrorism concerns imposed by governmental regulations. As a result, companies using chemicals are particularly susceptible to new regulations such as that proposed by the European Union (EU). The EU will comprise approximately 27 countries by 2007. The EU has set forth comprehensive statutes designed to regulate any company using chemicals for manufacture. These statutes are known as the Registration, Evaluation, and Authorization of Chemicals. i.e., the EU REACH protocol.

The EU REACH protocol is designed to provide a holistic system that addresses the life cycle for chemical use and exposure from the point of inception in the supply chain through manufacture, incorporation into products and use by humans, disposal to the environment and residual recycle to humans via water and the environment. The EU REACH chemicals management policies therefore encompass Registration, Evaluation, and Authorization of virtually all new and existing chemicals that are manufactured in or imported into the EU in quantities greater than one ton per year. This constitutes approximately 74,000 chemicals that will be regulated. In compliance with the EU REACH protocol, companies are required to not only meet the new requirements, but to demonstrate that the chemicals are safe when used as intended. The EU REACH protocol comprises five formal elements that companies must meet: 1) pre-registration; 2) submission of all vertebrate human safety and environmental data and relevant in vitro data; 3) registration; 4) evaluation; and, 5) authorization.

Chemicals that are produced or imported into the EU in quantities greater than 1 ton per year require a more rigorous registration under the EU REACH protocol. In addition, imported products comprising chemicals that are classified as dangerous, must also be registered and follow a more stringent set of guidelines under the EU REACH protocol. The burden on companies to meet these new requirements requires extreme diligence on their part: failure to do so results in the prohibition of chemical use in an EU country.

For instance, the evaluation element of the EU REACH protocol requires submitting technical documents that includes the identification, human and ecotoxicity data, information on expected product use, and physicochemical properties, among other information. These information requirements exponentially increase with higher production and import tonnage. For example, above ten (10) tons, human health, environmental risk, and risk management must also be assessed in a Chemical Safety Report (CSR) submitted to the EU. Even higher chemical volumes, e.g., greater than 100 tons annually, require additional long-term animal testing data.

In other words, companies need to quickly and efficiently provide information on the chemicals it is using, and identify any chemicals that are subject to authorization, e.g., carcinogenic, mutagenic and reproductive toxicants. All of this information must be made readily accessible for compliance with the EU REACH protocol in real-time. This is particularly burdensome on companies dally using a large number of chemicals. Currently, many companies may have the required data in separate systems; but, do not have the capability of integrating all of the required information for a single user to review in real-time.

For instance, chemical usage can come from a variety of sources, e.g., different manufacturing plants or suppliers located in different regions, and in a variety of different formats and languages. If the status of a chemical changes under the EU REACH protocol, the method of compliance immediately chances for that particular chemical. For example, if tonnage is greater than or equal to 10 tons for the chemical, then compliance must be immediate or else the company is precluded from using that chemical until compliance is met, and/or stringent penalties are applied by the governing body.

Therefore, a need exists to provide a chemical management system that provides accurate chemical usage information (tonnage/year) in real-time by each manufacturing plant, each technical center, all suppliers or any chemicals placed in a market by contractors that a company may use. Information pertaining to the import or manufacture status of a chemical in a country and its hazard ratings may dictate registration contents, priorities and timing with regard to the respective countries protocols. Additional information regarding safety and testing must also be provided in real-time to a user to enable him/her to comply with any protocols set forth by the country. A single chemical management system that can provide all of the requisite information, such as required by the EU REACH protocol, is desired. A need also exists for a chemical management system that can submit or provide all of the information required by the governing body in a relatively simple fashion.

### SUMMARY OF THE INVENTION

In general, the present invention, and in various exemplary embodiments, provides a chemical management information system and methods of using the same. The chemical management system captures chemical use on an on-going and real-time basis regardless of the source of data. The chemical management system integrates chemical usage information from a plurality of sources by a company, captures internal and external human and environmental safety information, integrates regulatory requirements, and identifies any gaps in information required for compliance with the regulatory requirements. The chemical management system enables a user to submit accurate information to the governing body in the required format and allows the user to monitor, in real-time, any changes in the chemical's usage.

As such, in one aspect, the present invention provides a chemical management system comprising: a first element comprising a chemical identifier tool including chemical identifier information; a second element comprising a web-based use capture tool integrating said chemical identifier information, wherein said web-based use capture tool gathers a company's external and internal chemical use information; a third element comprising a compliance tool integrating said chemical identifier information and evaluates said external and internal chemical use information against regulation requirements; a fourth element comprising a safety database search tool integrating said chemical identifier information, wherein said safety database search tool evaluates how much safety data is available in relation to said chemical identifier information; and a fifth element comprising a gap analysis tool, wherein said gap analysis tool identifies any gaps in information required for compliance with said regulation requirements.

In another aspect, the present invention provides a chemical management system comprising: a web-based use capture tool that gathers a company's external and internal chemical use information wherein said web-based use capture tool outputs chemical use information; a compliance tool integrating the chemical use information and integrating regulation requirements from a governing body, wherein said compliance tool outputs compliance information; a web-based external/internal safety information search tool integrating the chemical use information, wherein said web-based external/internal safety information search tool outputs safety information; a gap analysis tool integrating the safety information and the compliance information, and wherein said gap analysis tool outputs analysis information; and a data submission tool that outputs information selected from the group consisting of chemical use information, compliance information, safety information, and analysis information to the governing body.

In still yet another aspect of the invention, a method of using a chemical management system is provided comprising: inputting chemical identifier information for at least one chemical into a chemical identifier tool to output at least one chemical name; providing a company's external and internal chemical use information for said at least one chemical name and outputting said chemical use information with a web-based use capture tool; providing external and internal safety information for said at least one chemical name and outputting said safety information with a safety database search tool; providing at least one set of regulation requirements with a compliance tool; comparing said chemical use information and the regulation requirements with said compliance tool to output compliance information; and analyzing said compliance information and said safety information with a gap analysis tool to output gap analysis information.

### BRIEF DESCRIPTION OF THE DRAWINGS

The above and other advantages and features of the invention will be more clearly understood from the following detailed description which is provided in connection with the accompanying drawings.

FIG. 1 is a general illustration of the overall chemical management system in accordance with one embodiment of the invention.

FIG. 2 is a general illustration of the overall chemical management system in accordance with another embodiment of the invention.

FIG. 3 is a general illustration of the hardware schematic employed in using the chemical management system illustrated in FIGS. 1 and 2.

### DETAILED DESCRIPTION

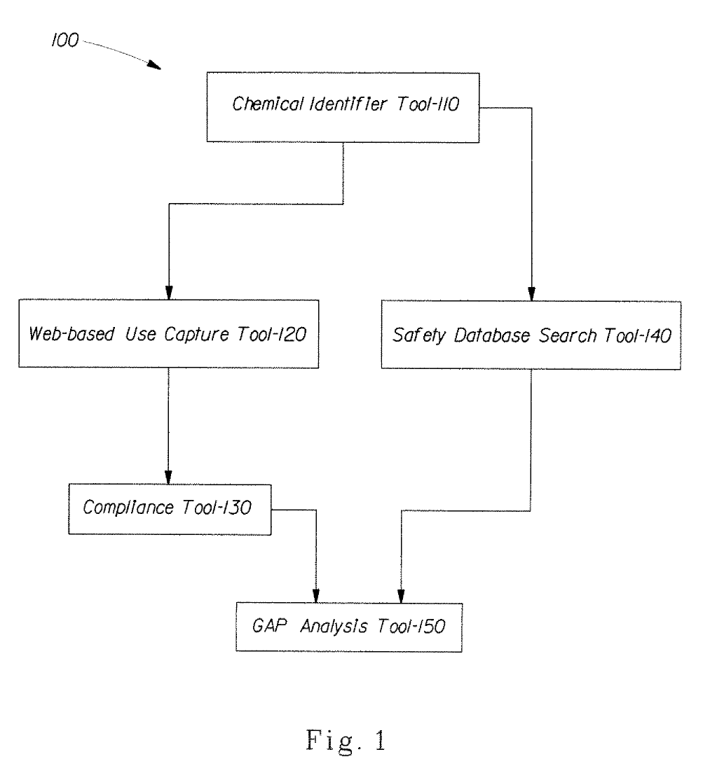

In the following detailed description, reference is made to the accompanying drawings (FIGS. 1-3) which form a part hereof and illustrate specific exemplary embodiments by which the invention may be practiced. It should be understood that like reference numerals represent like elements throughout the drawings (FIGS. 1-3). These embodiments are described in sufficient detail to enable those skilled in the art to practice the invention. It is to be understood that other embodiments may be utilized, and that structural, logical, the addition or omission of elements or steps, and electrical changes, may be made without departing from the spirit and scope of the present invention.

All ranges given herein include the end of the ranges and also all the intermediate range points.

The term “comprising” refers to various components or steps that may be conjointly employed, although additional steps or components may be utilized, if desired. Accordingly, the term “comprising” may encompass the more restrictive terms “consisting essentially of” and consisting of.

The term “internal” is used in the broadest sense and refers to any information a company may internally obtain of a chemical through its manufacturing plants, supply plants, vendors that supply the chemical to the company, different business units within the company, contractors, sales of the chemical, and any other daily activities of the company that generates information usage of the chemical, among others. For example, a company may sell, manufacture, or incorporate the chemical in its products. This generates internal information which may also include how the chemical is disposed of in the environment, e.g., by a manufacturing plant or used by a consumer. An outside vendor may not be able to supply as much of the chemical as a company may desire, and, this information is considered internal since it is affects the daily activities of the company and generates information on the usage of the chemical, e.g., there is less chemical for the company to use. The term “internal” also refers to any internal information regarding the safety of chemicals including, but not limited to, safety studies, information and/or calculations to project hazard ratings of chemicals, methods and/or data to project hazard, risk, assessing risk, exposure scenarios, and the like.

The term “external” is used in the broadest sense and refers to any information that is not internal to a company such as from other companies, publicly viewed websites, and the like. For instance, such information may comprise chemical names, certain identifiers for chemicals such as the CAS number, the EINCES number, safety studies, and any other information relating to the safety of chemicals and regulatory criteria for the chemicals.

The term “endpoint(s)” is used in the broadest sense and refers to any information that include but is not limited to aquatic toxicity (which also includes acute and sub-chronic), biodegradation, activated sludge, absorption, hydrolysis, irritation (skin, eye and respiratory tract), skin corrosivity, mutagenicity, genotoxicity, acute toxicity (any route), skin sensitization (dermal and respiratory system), repeated dose toxicity, sub-chronic toxicity, toxicokinetics (absorption, distribution, metabolism, and excretion), reproductive toxicity, developmental toxicity, long-term repeated toxicity study, carcinogenicity, immunotoxicity, neurotoxicity, and derivation of DNEL(s) (no effect levels), among others.

In general, the present invention, and in various exemplary embodiments, provides a chemical management information system and methods of using the same. The chemical management system captures chemical use on an on-going and real-time basis regardless of the source of data. The chemical management system integrates chemical usage information by user input and from a plurality of company resources. It captures internal and external human and environmental safety information from internal and external databases. It integrates regulation requirements such as the EU REACH protocol in algorithmic format into the use and safety information and identifies gaps in information needed for compliance with the regulation requirements. Consequently, the chemical management system identifies the resources and timing required to comply with the regulation requirements. This enables a user to submit accurate information to the governing body in the required format. This also allows the user to monitor and set-up alarms with regard to changes in the chemical usage to ensure that compliance is met with the regulation requirements in a real-time basis. It further allows a user to search the captured information by endpoints dramatically reducing the amount of time required to obtain information, and streamlines efficiency.

The chemical management system and methods allows a company to monitor chemicals that the company uses or may be interested in using in order to ensure compliance with regulations and protocols of a governing body. For instance, the invention allows toxicologists or other individuals at the company to assess the risk of chemicals very efficiently and quickly by using endpoints. It minimizes the resources and time required to conduct searches for conducting safety assessments. Typically, to search 129 chemicals, it would take at least 1 month and a team of many individuals searching one website at a time, and one chemical at a time in a linear sequential fashion. The disclosed chemical management system and methods can do the same search in a matter of hours, e.g., about 4 hours for 129 chemicals because the chemical management system and methods enable searches of multiple websites with all 129 chemicals at the same time. The results are displayed within moments of the search request, and a single individual can conduct the search to retrieve information required for the chemical safety assessments.

The invention further allows a company to comply with chemical management requirements around the world. For purposes of a simplified description, the chemical management system and methods, in its various embodiments, is described as being used to comply with the EU REACH protocol. It should be appreciated, however, that the chemical management system and methods can be used with equal utility by a company for its own record-keeping or to comply with another governing body's set of regulations.

FIG. 1 illustrates a chemical management system 100 with a chemical identifier tool 110 including chemical identifier information; a web-based use capture tool 120 that integrates the chemical identifier information, and gathers a company's external and internal chemical use information; a compliance tool 130 that evaluates chemical use information against regulation requirements; a safety database search tool 140 that integrates the chemical identifier information, and evaluates how much safety data is available in relation to the chemical identifier information; and a gap analysis tool 150 that identifies any gaps in information required for compliance with the regulation requirements provided by the compliance tool 130.

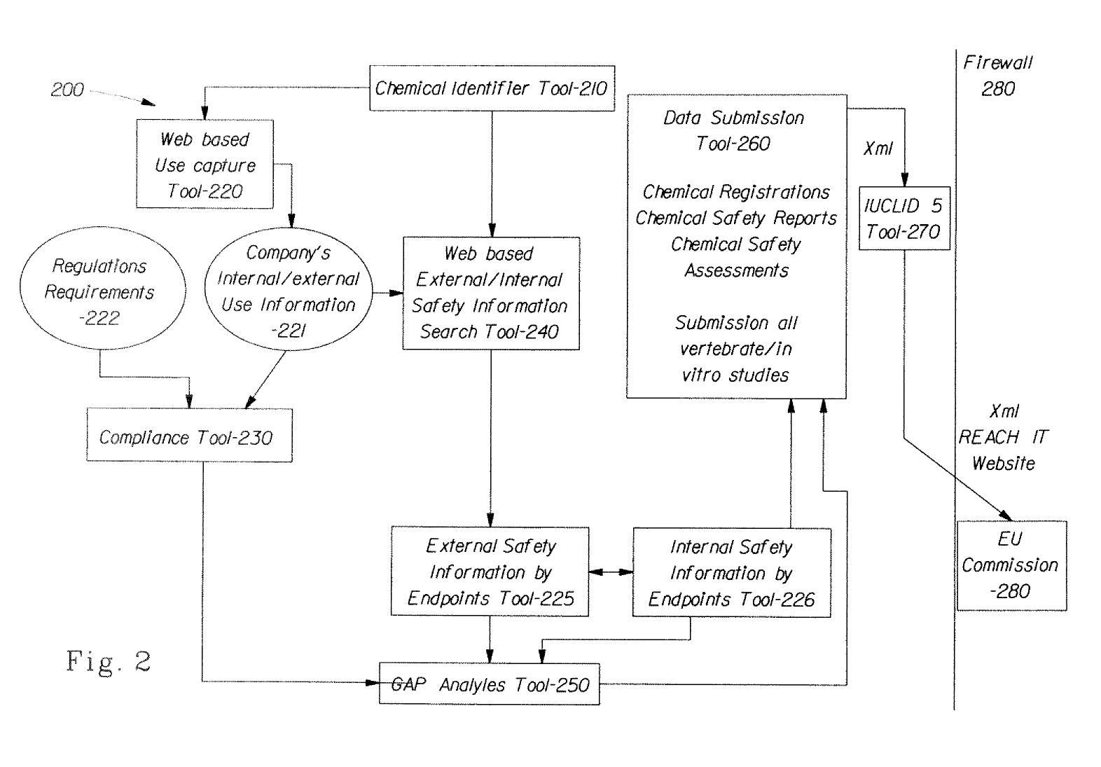

FIG. 2 illustrates a chemical management system 200 with a web-based use capture tool 220 that gathers a company's external and internal chemical use information 221; a compliance tool 230 that integrates the chemical use information 221 and integrates regulation requirements 222 from a governing a body; a web-based external/internal safety information search tool 240 that integrates the chemical use information 221, and outputs external safety information 225 by endpoints and internal safety information 226 by endpoints; a gap analysis tool 250 that integrates the safety information 225, 226 and the compliance information, and outputs analysis information; and a Data Submission Tool 260 that outputs required information for compliance to the regulation requirements to the governing body. FIG. 2 further illustrates that the internal safety information 226 can be outputted to the Data Submission Tool 260 directly. The Data Submission Tool 260, in one embodiment, may convert information into a data format required by a governing body such as XML. In the embodiment illustrated in FIG. 2, the data format is for the IUCLID5 data storage platform 270. The information submitted from a company is electronically submitted through at least one firewall 280 to the EU Commission 280, e.g., the EU REACH website. Furthermore, any electronic communications, chemical and safety submission packages, or the like, required to meet regulatory requirements can be submitted through any communication tool in a proper format meeting the governing body's requirements. For instance, there are 3 tools involved in submitting the information to the EU: 1) first is IUCLID 5 Tool 270 for safety reports; 2) second, is the REACH IT website for communications with EU commission on the submissions; and 3) is a tool that is still yet to be defined by the EU commission, which is the actually submission platform for the Registration, Chemical Safety Reports, Chemical Safety Assessments.

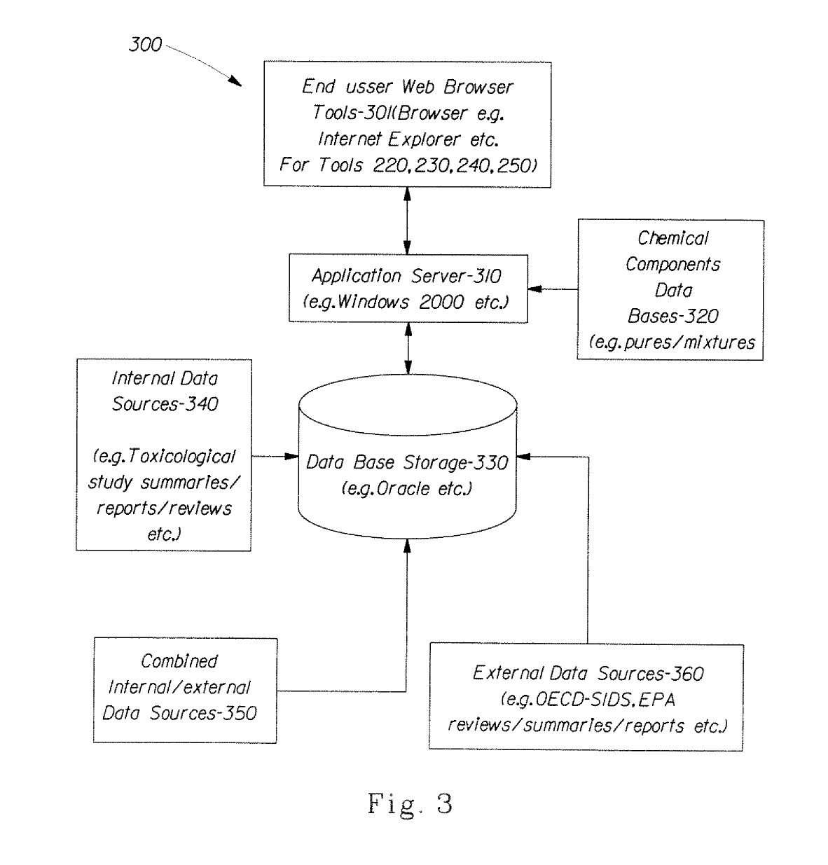

FIG. 3 illustrates the hardware schematic employed in using the chemical management system illustrated in FIGS. 1 and 2. FIG. 3 illustrates an End User Web Browser tool 301. The End User Web Browser Tool 301 can be Internet Explorer and used with tools 220, 230, 240 and 250 of FIG. 2. The End User Web Browser tool 301 interacts with an Application Server 310, e.g., Windows 2000 or Windows XP. The Applications Server 310 interacts with the Chemical Components Database 320 and Database Storage 330. The Chemical Components Database 320 and Database Storage 330 can be a single database or a plurality of databases. The Database Storage 330 can be Oracle for instance. The Database Storage interacts with a company's Internal Data Sources 340, External Data Sources 360 and a combined Internal/External Data Sources 350. Each of the sources, 340, 350, and 360, can be a single database or site, or can be a plurality of databases or sites.

Referring now back to FIG. 1 the chemical identifier tool 110 is used for the identification of chemicals worldwide. The chemicals can be experimental or already in existence. The chemical identifier tool 110 identifies and groups the chemicals by name. Common chemical naming systems are IUPAC nomenclature, EINECS nomenclature, common names, alternate names, or by a numbering system such as the CAS numbering system, EINECS numbering system, or an internal company's numbering system. The chemical identifiers are pulled and stored into a database for use in the chemical management system.

The purpose of the chemical identifier tool 110 is to merge internal and external information regarding the chemical's name and/or number. For instance, a company may use its own numbering system, e.g., a GCAS numbering system of The Procter & Gamble Company (P&G) that identifies chemicals which are produced by P&G, different from a standardized numbering system, e.g., a CAS numbering system. The chemical identifier tool 110 integrates the company's particular way of identifying chemicals, e.g., internal way, with external information. The chemical identifier tool 110 may optionally comprise a separate database that stores the external and internal chemical identifier information. The chemical identifier tool 110 may also take and convert the chemical identifier information into a form that allows the company to communicate with a governing body or outside companies. For example, internal chemical identifiers particular to the company must be converted to externally recognized and accepted chemical identifiers, e.g., a CAS number. The chemical identifier tool 110 also categorizes the chemical identifier information into various categories such as a pure chemical category and a mixture category, among others. This enables a company to reduce a composition or mixture down to its components. This is particularly useful for companies that manufacture complex chemical compositions such as fragrances.

In one embodiment, the chemical identifier tool 110 comprises an internal database and is linked to at least one external database. The internal database may comprise chemical identifiers that are particular to the company. The external database may comprise chemical identifiers from IUPAC nomenclature. EINECS nomenclature, common chemical name, common trade name, master chemical name, and CAS number, among others. The chemical identifier tool 110 obtains the information from the at least one external database and saves the information in the internal database, or, may save the internal and external information in a completely separate database. In other words, the chemical identifier tool 110 integrates external and internal chemical identifier information.

Referring now to FIGS. 1 and 2, a web-based use capture tool 120 and 290 is illustrated. The web-based use capture tool 120 and 220 is a data entry and capture tool that captures internal and external chemical usage from a manufacturing plant, contract manufacture, laboratory, outside supplier, or any other sources such as from purchasing, marketing, and/or sales information that a company may use or obtain a chemical from. The web-based use capture tool 120 and 220 can capture internal and external chemical usage collectively across a plurality of sources, or, it can provide chemical usage information from a single source. For purposes of a simplified description, the chemical management systems 100, 200 are described as being used to monitor a manufacturing plants usage of a chemical.

The web-based use capture tool 120, 220 can allow a company to obtain an initial snap shot in real-time from a segment of manufacturing plants located in a particular geographic region, e.g. the EU, of a chemical's tonnage, regardless of how the manufacturing plants obtained the chemical. The web-based capture tool 120, 220 further allows a company to see how the chemical is provided to the manufacturing plants, e.g., by importation, manufacture, locally supplied, and the like, and in the exact amounts. The web-based capture tool 120, 220 can even provide a single manufacturing plant's information with regard to chemical usage or a plurality of plants within a given geographic region. In essence, the web-based use capture tool 120, 220 captures, for a company, what chemicals the company uses, how much of the chemical the company uses, and where the chemicals are being used. This is important under the EU REACH protocol since all chemicals present, whether imported or not, in an EU country are subject to the regulation requirements of the EU REACH protocol.

As indicated above, the chemical sourcing and usage information can be obtained from multiple sources such as different business units within the company, different plants the company uses, different suppliers the company employs, different contractors, and the like. The data streams can originate from different static and/or automated data sources such as from purchasing, product supply, business warehouse, manufacture, marketing, R&D laboratories, contract manufacturer's, among others. The web-based use capture tool integrates all of this information, including any information that a user may manually input or information from data streams brought in automatically from other use capture systems. This provides a centralized internal database comprising all of the chemical use information for a company. The internal centralized database provides an accurate snap shot or real-time chemical usage by the company. It should be, appreciated that multiple internal databases can be used to store this chemical use information; however, all of the databases should be linked together, e.g., can electronically communicate with each other, to allow a user to quickly obtain the information stored in each database. The web-based use capture tool 120, 220 can provide real-time and on-going chemical use information from all plants and chemical use sources on a global basis for or company. A chemical's location of use is particularly important in complying with regulation requirements. The web-based use capture tool 120, 220 captures any and all information for existing chemicals and even for experimental chemicals.

Under certain regulation requirements, it is important to know the discharge of the chemical in a mixture. For example, in a fragrance, the sales and marketing department of a company may need to know the volume by country, and the discharge of that chemical into the environment. The EU REACH protocol requires an environmental assessment since a fragrance chemical is discharged into the air and can affect water, fish toxicity, sewage, and the like.

In one embodiment, the web-based use capture tool 120, 220 provides external and internal chemical use information for a company by automated data streams. The information generated is provided in an ‘in-time’ and ‘on-time’ fashion. The term ‘in-time’ means as soon as chemical information is generated and occurs, the information goes into the web-based capture tool 120, 220 directly and automatically. The term ‘on-time’ means as soon as information is made and captured, the governing body can be immediately notified if a chemical's usage information changes require compliance with different regulation requirements. The web-based use capture tool 120, 220 accesses information from internal databases to the company, e.g., databases that can only be accessed by a company's employee, agent or affiliate.

The web-based use capture tool 120, 220 allows a company to begin developing strategies for compliance, and also serves as a check tool to ensure that data is entered correctly. For example, the chemical use information provides a company with notification of what chemicals need to be registered and the timing required to register them. Under the EU REACH protocol, certain hazardous chemicals require quicker registration than non-hazardous chemicals. The web-based capture tool 120, 220 serves as a check tool to ensure accuracy of entered information by comparing a company's particular chemical identifier information against a recognized chemical identifier, e.g., against a CAS number. The web-based capture tool 120, 220 also allows a company to outline the key suppliers of the chemical they may need to employ to obtain the chemical. A company can see information that an outside vendor they use supplies 100 tons to an EU country and is easily capable of meeting the company's demands of 10 tons. Alternatively, if the company determines that they need 200 tons of the chemical, the company knows that they must seek another vendor supplier.

The web-based use capture tool 120, 220 also allows a user to manually input chemical information obtained from outside the various internal databases that are integrated, if desired. The web-based capture tool 120, 220 imports chemical information from various sources within or internally accessible by the company, and even those external to the company, and saves the results in an internal centralized database allowing for the information to be provided in different formats on the mainframe and PC, e.g., Oracle, Xml, Excel, Access, or Microsoft Word, among others. The web-based capture tool 120, 220 can also incorporate an automated reporting or alarm system that alerts the company or user for changes in the chemical use and registration priorities dictated by the EU REACH protocol.

The manual data entry portion of the web-based capture tool 120, 220 allows information to be entered by a user to capture information on pure chemicals, chemical mixtures, and components in each mixture. A user enters the chemical management system through a unique identifier including a username and password. Data entries are automatically checked for accuracy. For example, filters are incorporated to ensure that all of the tonnage entries for each chemical are in a non-negative number format, CAS or GCAS numbers are entered with the correct format and percentages are reflected as greater than 0 and 100 percent or less. Required fields cannot be left empty (green fields for example), while optional fields (yellow fields for example) can be left empty if data is unavailable. Users are prompted to correct all errors (tagged in red for instance) when detected by the web-based capture tool 120, 220 and corrections are required before proceeding to the next component. Additionally, use information can be entered on spreadsheets, such as Microsoft Excel and uploaded into the Use Capture System and similar accuracy checks, such as filters are applied to facilitate entries into the web-based Use Capture Tool.

During the post-entry phase of the web-based capture tool 120, 220, a user is able to display, view, edit and delete information they previously entered through interactive tabs. The user can also view information entered by other users; but, can be precluded from editing the other user's inputted information unless they have administrative capabilities. Customized searches are also available by use of SQL statements in a text area.

Referring now to FIG. 1, a Safety Database Search Tool 140 is provided for chemical management system 100. In FIG. 2, a web-based external/internal safety information search tool 240 is provided for chemical management system 200. It should be appreciated that safety database search tool 140 operates and is configured in a substantially similar manner to the web-based external/internal safety information search tool 240. For purposes of brevity and a simplified description, reference is made to the safety database search tool 140.

The safety database search toot 140 integrates the information from the chemical identifier tool 110 and provides safety information for the chemicals. Consequently, the safety database search tool 140 goes across any databases that may contain safety information, whether internal or external, and obtains the safety information. The safety information can be initially provided by internet links to the databases that comprise the safety information if the information is external to the company. If there is no safety information available for a particular chemical, then the safety database search tool 140 may group chemical structures together and provide a projective study. For example, chemical structures may be grouped based on structure reactivity.

As indicated above, external safety information data sets and reviews could be obtained. The external safety information can be saved in a separate internal database, or can be provided as an internet link to the external source from which the external safety information is contained. In addition, internal safety information data sets and reviews can be provided. The internal safety information can comprise any safety studies conducted by a company. For example, the internal safety information may comprise toxicological studies, environmental impact studies, and the like. In addition, it can comprise of projections of hazard and safety of the chemicals based on structure/reactivity (QSAR), toxicological properties of chemicals in a similar class, calculations, in vitro data, and/or modeling information, among others.

In one aspect, the safety database search tool 140 provides a company with the ability to determine how much safety information is available externally and internally. For example, a company may internally have over 24,000 studies in vertebrate and in vitro in the form of summaries or reports. A company may have additional safety information on carcinogenicity, chronic, non-clinical sensitization, reproductive development, sub-acute toxicity, sub-chronic, genotoxicity, developmental toxicity, acute toxicity and their own environmental studies, among others. In one embodiment, the safety database search tool 140 is a web-based search tool that can search for safety information with regard to a single chemical or as many chemicals as may be required, and by endpoints, if desired.

To develop the safety database search tool 140, the chemical identifier tool 110 provides information into external safety and government websites and links to the safety information is established based on the chemical identifier data. The safety database search toot 140 electronically links the chemical identifier records to any external record, allowing retrieval of electronic reports, summaries, or information, on the chemical in the external sites. The safety database search tool 140 may also be configured with an additional tool to extract the presence or absence of external information by specific safety endpoints, e.g., carcinogenicity, mutagenicity, reproductive toxicity, and the like to enable an assessment of gaps in safety information in the subsequent gap analysis tool 150, 250. It should be appreciated that the safety database search tool 140 can be configured to also use internal safety information of a company in a similar manner as disclosed for the external safety information. In this case, internal databases would be accessed by the safety database search tool 140. Internal safety information may be present in internal centralized databases or other electronic databases through the matching of the internal safety information with the chemical identifiers database outlined above. The safety database search tool 140 can be a powerful time-saving asset to a user and company.

For example, there are greater than 100,000 chemicals in existence today. Approximately 20,000 chemicals have safety information that can be accessed through an external database or reviews pertaining to human and environmental safety. There are at least 20 key external human safety databases and 5 external environmental safety databases that contain key toxicological and environmental safety information. Some of the external databases are publicly available and some of them are confidential, such as OECD/SIDS, HPV, ESIS, HERA, BIBRA, CTFA, JEFCA, WHO, EAFUS, EPA, ExiChem, ICSC, NIOSH, IARC, Environmental Canada, TOXNET, ECOTOX, European Cosmetic Safety Site, ACQUIRE, Prop 65, FEMA/RIFM, CTFA, US-NTP, CCRIS, DART, China chemical management, and others. Additional chemicals with external databases or reviews can be added as new sources are identified.

As a result, a key resource needed to assess and define the strategy, priority, and estimated effort for compliance with regulation requirements, e.g., the EU REACH protocol, is toxicological information obtained from external safety reviews, databases, and internal toxicological data/toxicological projections. Typically, companies conduct these types of safety searches in a linear sequential fashion. In other words, data searches are conducted one chemical and one database at a time. The present invention nullifies this time-consuming process and streamlines it.

In one embodiment, at least 21 external safety reviews/databases are incorporated by internet deep-links to the external databases. In another embodiment, at least 20 key human toxicological and environmental safety reviews/databases are incorporated by internet deep-links to external databases. Thus, at least 20,000 chemicals with external safety data are provided. The combination of other databases allows for at least 80,000 chemicals to be evaluated. As a result, a user can immediately gain access to any of the databases simultaneously by searching. This also reduces the redundancy of searching multiple databases individually since many times no information is available.

A search that would normally take 4 days now can take hours, and the accuracy of the information is substantially increased. One of the main problems solved by the present chemical management system is that in searching toxicological data, a user does not know if information exists externally, which means that the user must often search the same sites again and again; one chemical at a time merely to find out no safety information exists for that chemical. The present invention enables the user to immediately retrieve key reports or data associated with large groups of chemicals by reviewing all of the incorporated external databases. If no data exists in any of the external databases, the user immediately knows.

If safety information is present for the chemical when using the safety database search tool 140, then a positive indicator such as an icon will be available for the user to click on to deep-link directly to the database, a page directing to the report/data, or directly to the review or report. The icon can also be configured to allow the user to scroll-over it and a small window appears with information that either summarizes the safety information or provides an internet webpage of the database. Another option is to provide search engine functionality enabling the user to determine if additional outside data or reports on a given chemical, beyond the pre-set sites is available.

In another embodiment, illustrated in FIG. 2, a web-based external/internal safety information search tool 240 is provided in chemical management system 200. The Safety information search tool 240 is configured and operates in a similar manner to the safety database search tool 140 of FIG. 1 with a couple of additional features. In this embodiment, the Safety information search tool 240 also has the ability to separate and sort safety information by endpoints. An ‘endpoint’. e.g., carcinogenicity, mutagenicity, and the like, can be used to quickly sort through the safety information. For example, if a user wants to know all chemicals with a carcinogenic factor greater than ‘x’, then, all chemicals with safety information containing carcinogenic factors great than ‘x’ would be provided. In FIG. 2, external safety information is sorted by endpoints 3a. Similarly, internal safety information is sorted by endpoints 3b. It should be appreciated that the external and internal safety information can be combined in a single database or stored in separate databases, and as a result, the endpoints of external and internal safety information can also be combined.

In order to determine which chemicals to register and provide safety information for, under the EU REACH protocol to ensure compliance, a compliance tool 130, 230 based on algorithm is derived from EU REACH protocol regulation requirements is used. This compliance tool 130, 230 integrates chemical use information from the web-based use capture tool 130, 230 with EU REACH protocol regulation requirements. Incorporated into this compliance tool 130, 230 is the ability to detect changes in chemical use to provide alarms to a company or user if compliance requirements change.

It should be appreciated that although the invention is described as being used with EU REACH protocol regulation requirements, any regulation requirements can be incorporated into the compliance tool 130, 230. For example, the chemical management system may be used for compliance with the Canadian DSL or the Chinese REACH requirements, among others. In addition, it does not have to be a governing body's regulation requirements incorporated by algorithms into the compliance tool 130, 230. For example, a company may proscribe their own internal set of regulation requirements into compliance tool 130, 230 in conjunction with or in lieu of a governing body's regulation requirements.

The information obtained from the compliance tool 130, 230 allows a user and company to quickly identify the information they will need or need to obtain to ensure compliance with the EU Reach protocol regulation requirements. For instance, a user is able to determine if the EU Reach protocol requires a registration, a chemical safety report, a chemical risk assessment, authorization, among other criteria, for a particular chemical because of the company's usage of the chemical with data being integrated from the web-based use capture tool 120, 220. The compliance tool 130, 230 also provides information on timing.

Under the EU REACH protocol, depending upon the usage of the chemical, e.g., the tonnage, compliance is dictated by how many safety studies need to be completed; the chemical's hazard rating; registration requirements, and many other factors. These elements are required to be completed in stages and by certain periods. The compliance tool 130, 230 analyzes multiple sets of information to enable compliance relative to the regulation requirements. The compliance tool 130, 230 also provides a user and company the ability to monitor and change the regulation requirements.

The compliance tool 130, 230 can also be configured with alarms, such as an email to a user, that reports any change in a chemical's usage that would require further compliance steps to be taken by the company. The compliance tool 130, 230 also provides an original baseline of chemical usage and the delta, e.g., change in usage, of a chemical. The information integrated and evaluated by the compliance tool 130, 230 is stored internally in at least one database.

Compliance tool 130, 230 of the chemical management system 100, 200 is an internal analysis tool used by a company that can also provide different responses that could be made by the company to bring it into compliance with the EU REACH protocol. For example, the EU REACH protocol requires more than 100,000 chemicals to be registered. The compliance tool 130, 230 provides at least 2 different ways of compliance for each chemical, and in some instances up to 14 different variations for compliance, if not more. As a result, there can be over one million outcomes provided by the compliance tool 130, 230 when 14 variations are used for more than 100,000 chemicals. The compliance tool 130, 230 uses information from the web-based capture tool 120, 220 and integrates it with an internal database that analyzes ways of compliance with the EU REACH protocol.

The internal database of the compliance tool 130, 230 uses information from the web-based capture tool 120, 220, such as the volume of chemical use, the number of registrations for the chemicals required, chemical study reports (CSR), chemical safety assessments (CSA), and other data, to determine EU REACH protocol compliance based on algorithms developed by the company. As indicated above, the compliance tool 130, 230 can also incorporate an automated alarm system which sends out alerts, e.g., by an email to the user or designated representative, if change in the data streams from the web-based capture tool 120, 220 occurs.

In essence, the compliance tool 130, 230 provides a user and company the ability to determine the number and timing for registrations of the chemical, CSR's, and CSA's needed to obtain EU REACH compliance, among other factors. It also enables the user and company to monitor any changes in the chemical use from plants, contract manufacturers, and the like, to keep the user and company apprised if a different strategy for obtaining compliance is needed. The compliance tool 130, 230 also provides different variations, e.g., strategies for compliance, and the user and company can then estimate the amount of resources required to meet each variation and select one that is optimal for their needs. Consequently, it allows the user and company to prioritize their efforts in reviewing the data for compliance with different chemical management programs such as the EU REACH protocol. For example, it allows the user to suggest strategies for consortia with other companies, if desired. It also allows the user to identify and outline any additional testing that may be needed or required under the EU REACH protocol.

Referring still to FIGS. 1 and 2, a gap analysis tool 150, 250 is provided. The gap analysis tool 150, 250 serves to support EU REACH compliance, the integration and the optimization of the various components comprising the chemical management systems 100, 200. The gap analysis tool 150, 250 serves as the final output of the information obtained from the web-based capture tool 120, 220, compliance tool 130, 230, and the safety database search tool 140 for chemical management system 100 of FIG. 1, or the web-based external/internal Safety information search tool 240 for chemical management system 200 of FIG. 2.

In essence, the gap analysis tool 150, 250 provides gaps between the requirements of the EU REACH protocol and the amount of data the user and company has; provides the ability for the user and company to evaluate if a consortia strategy should be developed; defines the amount of resources required to obtain compliance with the EU REACH protocol; identifies vulnerabilities in the data; and estimates the cost of generating any missing data versus buying the necessary data for compliance, among others.

For example, the gap analysis tool 150, 250 may identify vulnerabilities such as human and environment concerns relating to toxicity. Specifically, if the identified concerns is a persistent or a cumulative effect of the chemical or a specific toxicological issue. In the compliance tool 130, 230, any negative information would be sent out in an email alerting the user and company that a report needs to be filed with the governing body, if the governing body dictates that negative information be submitted. For example, some governments require that a report must be filed within 72 hours of death caused by a chemical. The consortia strategy element of the gap analysis tool 150, 250 enables a user and company to determine if a company should collaborate with another company to defend a product or even share information. The timing of the registration also is dependent upon the supplier's capabilities of providing the chemical. This information was obtained by the web-based capture tool 120, 220.

The gap analysis tool 150, 250 ties together the data from the other tools of the chemical management systems 100, 200 to support EU REACH compliance and integration with a company's internal systems in a highly leveraged and optimized fashion. The output of the gap analysis tool 150, 250 provides data such as registration, CSR's, CSA's, authorization, and classification or notification priorities with respect to the company and suppliers. The gap analysis tool 150, 250 provides short-term and long-term strategies for EU REACH compliance. The gap analysis tool 150, 250 further allows a user and company to identify gaps in the information required for compliance by reviewing external and internal information provided by the other tools.

The information obtained by the other tools of the chemical management systems 100, 200 can be provided in an integrated single internal database of a company, a plurality of internal databases, or even a combination of internal and external databases. Multiple chemicals can be manually inputted by a user or extracted from a linked database rather than just a single chemical tied to a single database to allow quick and thorough results to be provided.

In another embodiment illustrated in FIG. 2, the chemical management system 200 may also comprise a database submission tool 260, firewall 280, and external storage platform 270. All electronic communications with a governing body can be conducted in this embodiment without significant user inputs. The data obtained from the gap analysis tool 250, can be provided by database submission tool 260 through firewall 280 to the governing body's storage platform 270. In a similar manner, all internal safety information by endpoints 3b, can also be directly provided by the database submission tool through firewall 280 to the governing body's storage platform 270. The submission by the database submission tool 260 can be manual or occur automatically at predetermined times, or immediately upon receipt of new information.

The database submission tool 260 also is configured to change the data it receives into a format that is acceptable to the governing body. For example, if the data the database submission tool 260 receives is in EXCEL format and the governing body requires all information to be in PDF format, then the database submission tool 260 can covert the EXCEL data into the appropriate PDF format. It should be appreciated that any format can be used. The database submission tool 260 allows a user and company to directly interact with a governing body through any firewall so that the records can be continuously updated, when necessary. It should also be appreciated that the embodiment in FIG. 2 can be configured to submit data to an external database or even to another company, if desired. For EU countries, there is a communication submission tool called REACH IT which is dictated and comes directly from the EU commission, and yet another tool is to be defined tool by the EU commission for submitting Registration CSR, CSA, authorization packages to the EU commission.

A method of using the chemical management system 100 of FIG. 1 is now disclosed. It should be appreciated that additional steps can be added, and even omitted depending upon the desired utility of the chemical management system 100, and that the methods disclosed herein are equally applicable to the chemical management system 200 illustrated in FIG. 2.

The chemical management system 100 can be used as an internal or external software program accessible through the internet. A userid and password allows access to the software program. A screen is provided where a user inputs information on whether it is a pure chemical or a mixture of chemicals being searched by use of tabs to indicate such. A user clicks on the appropriate tab located at the top of the internet page. A mixture of chemicals is defined as containing at least two chemical substances. For example, 20% of sodium sulphate in water is considered as a mixture comprising 20% sodium sulphate and 80% water. The search terms allow for a chemical to be searched with partial or full information by the CAS number (or CAS sequence without dashes). GCAS number, Identifier, or Chemical Name. The identifier is a label that a company may use internally to identify a chemical different from the CAS number or Chemical Name, or it can be a GCAS number, Wella ID, DP-Code, or the like. The Chemical Name can be the common name, the trade name, the IUPAC name, or an abbreviation. The software program then provides the desired data.

A method of entering, modifying, or deleting a pure substance of the chemical management system is now disclosed. It should be appreciated that additional steps can be added, and even omitted depending upon the desired utility of the chemical management system. A user selects the desired chemical after it is entered through the steps disclosed above. At this point, some of the chemical's information is automatically loaded from a database (or a plurality of databases that have been integrated to provide the information), and information can be entered and saved at this point. For instance, the company identifier or trade name can be entered.

Next, the hazard classification of the chemical is inputted. The hazard classification comprises of two selection windows: (1) hazard class symbols; and (2) hazard class risk phrases. A user should select all that apply to the particular chemical. In some cases, the information may be provided automatically. Next, a user chooses the direct supplier of the chemicals from an existing list or creates a new supplier to add. The user carries out the same steps for a company's production sites, and additional web pages can be provided indicating the source of the chemical for a company, if desired. A user inputs information specific to the company. For example, each site of the company that uses the chemical can be added, the volume the particular business unit, and product category among other information. The software program automatically saves the information each time a new page is loaded or at the very end can be saved by clicking a button.

Optional information can be provided such as potential or future suppliers of the chemical, or the total volume of the chemical within a given geographic region. At this point, the information can be saved by clicking on a ‘Save’ tab button. A user confirms that the information should be saved, even if all of the information is not known. Different ways can be employed to differentiate information provided versus information not known. For instance, the color background of information not provided is different from the background of the information that is known. For example, a yellow background is used to indicate Gaps' in the information. A red background indicates that the information is known. A user can save the information as an incomplete profile. A user can also enter, modify, and delete a pure substance record. A user can also enter, modify and delete a mixture record.

In these actions, a user selects the mixture tab and inputs the desired chemical providing the information. The user then inputs information for the mixture. Some of the chemical's information is automatically loaded from a database (or a plurality of databases that have been integrated to provide the information), and any information can be entered, modified, or deleted. For instance, the company identifier or trade name can be entered.

Next, a user chooses the direct supplier of the chemicals from an existing list or creates a new supplier to add. The user carries out the same steps for a company's production sites, and additional web pages can be provided indicating the source of the chemical for a company, if desired. A user can input information specific to the company. For example, each site of the company that uses the chemical can be added, the volume, the particular business unit, and product category, among other information. The software program automatically saves the information each time a new page is loaded or at the very end can be saved by clicking a button.

The individual components of the mixture is inputted, and a search for the individual chemical is conducted by entering partial to full information by using, the CAS number, identifier, or chemical name. Some of the chemical's information is automatically loaded from a database (or a plurality of databases that have been integrated to provide the information), and information can be entered and saved at this point. For instance, the company identifier or trade name can be entered.

The hazard classification of the chemical is inputted. The hazard classification comprises of two selection windows: (1) hazard class symbols; and (2) hazard class risk phrases. A user should select all that apply to the particular chemical. In some cases, the information may be provided automatically. Next, the concentration information of the individual component in the mixture can be entered. If not known, the information can be saved at this point to be later filled in. The target, minimum and maximum percentages can be provided if known.

It should be appreciated that many times the information does not need to be inputted since a previous user already inputted the information and it was saved. The software program also enables a user to be specifically notified, e.g., an email, when the amount of a chemical, whether in pure substance form or a mixture, changes. As a result, a company can maintain compliance with the EU REACH's protocol through the use of alerts. The software program also allows a company to quickly see where information is missing that is needed, e.g., can provide an email alert if information is missing for a mixture of individual chemical.

FIG. 3 illustrates the hardware schematic employed in using the chemical management system illustrated in FIGS. 1 and 2. FIG. 3 illustrates an End User Web Browser tool 301. The End User Web Browser Tool 301 can be Internet Explorer and used with tools 220, 230, 240 and 250 of FIG. 2. The End User Web Browser tool 301 interacts with an Application Server 310, e.g., Windows 2000 or Windows XP. The Applications Server 310 interacts with the Chemical Components Database 320 and Database Storage 330. The Chemical Components Database 320 and Database Storage 330 can be a single database or a plurality of databases. The Database Storage 330 can be Oracle for instance. The Database Storage interacts with a company's Internal Data Sources 340, External Data Sources 360 and a combined Internal/External Data Sources 350. Each of the sources, 340, 350, and 360, can be a single database or site, or can be a plurality of databases or sites.

For example, an end user interacts with the web browser 301 to input data. Data is processed by the Application Server 310 and stored in the Database Storage 330. The Application Server 310 pulls or obtains data from the Chemical Components Database 320 to augment the end user's inputs from web browser 301. These can be multiple databases or a single database depending on the desired configuration. The data is captured and stored in the Database Storage 330. In future inputs of data, the end user does not have to input data and the Application Server 310 does not need to access the Chemical Components Database 320 since the information has already been stored in Database Storage 330. The only item that accesses the Database Storage 330 is the Application Server 310. The combined Internal/External Data Sources 350, Internal Data Sources 340 and External Data Sources 360 can write and store in the Database Storage 330. In another embodiment, the External Data Sources 360 and Internal Data Sources 340 pulls data out of the Database Storage 330.

The chemical management systems and methods of using the same described above, merely illustrates and discloses preferred systems and methods of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A chemical management system comprising:
a chemical identifier tool including chemical identifier information;
a web-based use capture tool communicating with said chemical identifier tool and integrating said chemical identifier information, wherein said web-based use capture tool gathers a company's external and internal chemical use information;
a compliance tool communicating with said web-based use capture tool and integrating said chemical identifier information wherein said compliance tool evaluates said external and internal chemical use information against regulation requirements;
a safety database search tool communicating with said chemical identifier tool and integrating said chemical identifier information, wherein said safety database search tool evaluates available safety data in relation to said chemical identifier information; and
a gap analysis tool, communicating with said compliance tool and said safety database search tool, wherein said gap analysis tool identifies gaps in safety information and gaps in compliance with regulation requirements.

2. The chemical management system according to claim 1, wherein said web-based use capture tool captures chemical use from plants, contract manufacturers, laboratories, suppliers or a combination thereof.

3. The chemical management system according to claim 1, wherein said safety data base search tool comprises external safety information from external databases and external websites.

4. The chemical management system according to claim 1, wherein said safety data base search tool comprises internal safety information.

5. A chemical management system comprising:
a web-based use capture tool that gathers a company's external and internal chemical use information, wherein said web-based use capture tool of outputs chemical use information;
a compliance tool communicating with said web-based use capture tool and integrating the chemical use information and integrating regulation requirements from a governing body, wherein said compliance tool evaluates said chemical use information against said regulation requirements;
a web-based external/internal safety information search tool communicating with said web-based use capture tool and integrating the chemical use information, wherein said web-based external/internal safety information search tool outputs safety information;
a gap analysis tool integrating the safety information and the compliance information, wherein said gap analysis tool identifies gaps in safety information and gaps in compliance with on requirements; and
a data submission tool that outputs information selected from the group consisting of chemical use information, compliance information, safety information, and analysis information to the governing body.
